(19) United States
(12) Patent Application Publication
(10) Pub. No.: US 2025/0224261 A1
(43) Pub. Date: Jul. 10, 2025

(54) COMPACT WATER METER

(71) Applicant: Ötletgazdák 2012 Kft., Miskolc (HU)

(72) Inventors: József Gábor VISZOKAI, Miskolc (HU); Péter HAMAR, Mályi (HU); Gergo VALASKA, Miskolc (HU)

(73) Assignee: Ötletgazdák 2012 Kft., Miskolc (HU)

(21) Appl. No.: 18/768,386

(22) Filed: Jul. 10, 2024

(30) Foreign Application Priority Data
Jan. 9, 2024 (HU) P2400020

(51) Int. Cl. G01F 1/06; G01F 15/00

(52) U.S. Cl. CPC G01F 1/065; G01F 15/005

(57) ABSTRACT

A compact water meter having a meter casing equipped with an inlet stub and an outlet stub, as well as a rotary valve in the cavity of the meter casing equipped with a through-flow channel. A rotatably embedded impeller is placed in the cylindrical seat of the rotary valve, an optical sensor is mounted via the sensor mounting bores formed in its rectangular seat, and a thermometer is placed in the measuring device bore. A closing cover including a switching lever is affixed to the meter casing, on which an electric motor and at least one battery is mounted, and which furthermore has a fitting casing including an electric control unit affixed to it.

### CROSS REFERENCE APPLICATION

The present application claims the benefit of priority from the Hungarian Application No. P2400020 filed on Jan. 9, 2024, the entire content of which is incorporated herein by reference.

### BRIEF SUMMARY OF THE INVENTION

The subject of the invention is a compact water meter that is capable of measuring and remotely reading water consumption, as well as shutting off the water supply if needed.

Conventional water meters operate on mechanical principles, and are only capable of metering and displaying water consumption. In recent years, “intelligent” or “smart” water meters have appeared on the market, allowing for the remote reading and monitoring of water consumption. These measuring devices are advantageous for both consumers and water suppliers, as they do not require a manual reading of the water meter, meaning that no workers need to be retained for this purpose. In addition, they provide real-time, or even moment-to-moment information about water consumption, reducing pipe network water loss for both water suppliers and consumers, resulting in considerable savings both in terms of cost and water resources. In particular, pipe ruptures in water supply networks can cause considerable property damage due to the high amounts of water running to waste, if the consumer does not notice the pipe rupture within a short time.

### BACKGROUND OF THE INVENTION

Devices capable of remotely monitoring water consumption can actually track water consumption moment-to-moment, allowing for the detection of pipe ruptures and leakage due to a malfunction in the network. If these devices are also supplemented with a remote controlled shut-off fitting, the water network can be shut off as soon as the malfunction is detected.

Water meters capable of remote reading and smart metering are the current state of the art, as noted in the patent documents put forward below.

Patent document US 2014/0165719 A1 describes a water metering system that includes a water meter, a ball-valve, a pressure generating system with a turbine and a flow regulating opening/shutting element, as well as a wireless communication system. The measuring system contains an inlet, an impeller encased in a magnet with one or two blades, and electric switches arranged in the vicinity of the meter casing. The liquid duct of the measuring system is linear, in order to reduce pressure losses. The energy generating system has two liquid ducts, one for pressure generation and the other for maintaining the desired water pressure.

Patent document EP 0769681 A2 describes a water meter equipped with an impeller that uses optical sensors to measure the quantity of water flowing through. This impeller is built into the casing of the water meter. The impeller shaft is wide with a stud in the middle, through which it is embedded in the water meter casing in such a way that it can be rotated. The wide design of the shaft allows for the application of a reflective coating. The coating is divided into smaller sectors, with alternating reflective and non-reflective sections. An infrared light source and an infrared sensor are placed over the shaft. When the impeller and its shaft rotate, the reflective and non-reflective surface sections alternate below the light source and the sensor. The infrared light source emits short impulses, which are reflected into the sensor in a greater proportion from the reflective sections than from the non-reflective sections. The rotation of the impeller-and thus the amount of water flowing through—can be calculated by detecting the reflections, and it can be forwarded via appropriate devices to the consumer or the service provider.

Patent document DE 2715239 A1 also describes a water meter equipped with an optical sensor. An impeller consisting of a disc fixed on a shaft is mounted inside the enclosure of the water meter, with a 90° angle between the disc and the shaft. There are blades installed on the disc, ensuring that the water flowing through the meter casing will rotate the impeller. There are evenly spaced bores on the disc, adjacent to the blades. A light source is mounted on one side of the disc, with a sensor transforming the light into electric impulses on the other. When the light source is switched on and the disc is rotated, light enters the sensor through the bores, and disappears in the sections between the bores. When the disc is rotated, the sensor records an intermittent signal. The speed of the disc and the amount of water flowing through can be deduced from the recorded signal, and can be forwarded via appropriate devices to the consumer or the service provider. The light source used is typically an infrared diode, and the sensor is a phototransistor.

In addition to devices using optic sensors, there are also known devices operating on magnetic principles. These water meters are equipped with impulse transmitters. The transmitter's impulse signal is ensured by a magnet placed on the impeller or casing of the water meter, which induces voltage as it passes in front of a coil. The emitted impulse signal indicates the amount of water flowing through, proportionally with the rotation of the impeller. Such a solution is described in patent document DE 3608807 A1, wherein an impeller is placed in the water meter, with a measuring element connected to it. The measuring device has a ferromagnetic rod, which rotates along with the impeller and the measuring device. Two coils are placed in front of each other on the outside of the water meter casing in such a way that the ferromagnetic rod and the coils are collinear for certain positions of the magnet. The rotation of the ferromagnetic rod can be identified with the coils, from which it is possible to deduce the speed of the impeller and the quantity of the water flowing through.

Other existing devices are mounted on conventional water meters to get the water meter reading. The essence of these solutions is that the dial-plate of the water meters are typically equipped with a moving element, for example a hand. This moving element is connected to a rev counter magnet or a metallic disc. The devices detect the movement of the hand, or the magnet connected to it.

Patent document JP 2002-90190 A describes a water meter comprising a measuring device, a communication unit for reading the meter, and an electrically operated valve unit. The rotating magnetic field of the permanent magnet placed on the upper part of the measuring device's impeller is detected by the magnetic sensor in the signaling unit, which then calculates water consumption with the help of a microcomputer. This data is transferred by the transceiver module in the signaling unit. The valve unit includes a permanent magnet and a coil, through which current is passed to open and close the valve.

The disadvantage of the known water meters suitable for remote or smart metering is that they tend to be complicated, and their mechanism differs greatly from that of the mechanical water meters used previously. Their production is complex and costly due to their unique construction, and they are unable to shut off the water supply in case of failure or malfunction, which required human intervention at the water intake point. The high power consumption of the devices can be another disadvantage, as they cannot be operated from batteries, or only for a limited period, rendering them unusable in certain locations.

In view of the above, our objective was to design a compact water meter that takes up little space, is designed to be suitable for remote reading, and can be operated with low energy consumption.

A further goal of ours is to allow the opening and shutting of the water meter's water supply using remote-controlled methods with low energy consumption, via an application installed on the consumer's mobile telecommunications device.

Yet another goal of ours was to simplify the water meter's structural design, to have it generally match the design of conventional water meters operating on mechanical principles, and to require no special procedures for the device's maintenance.

We achieved our goals with a compact water meter, with its meter casing equipped with an inlet stub that can be connected to the water supply network, as well as an outlet stub that can be connected to the consumer water network. The meter casing is designed with a cavity, housing a rotary valve rotating freely. The rotary valve includes a through-flow channel fitted to the inlet stub and the outlet stub of the meter casing in such a way that in a certain position, the rotary valve allows water to flow through it from the meter casing's inlet stub to its outlet stub. The inlet and outlet stubs house splined profiled sealings, which are pressed against the rotary valve if the water is flowing, and thus seal the through-flow channel.

The rotary valve has an off-centered body and a cylindrical skirt. The surface of the cylindrical skirt has a groove with sealing inside, which prevents the ingress of water into the space above the sealing. The through-flow channel is located inside in the off-centered body, and the off-centered body is pressed against the profiled sealing of the inlet and outlet stubs once the water begins flowing. The off-centered body has a centered, cylindrical seat housing a freely rotating impeller with blades. The impeller is mounted on a shaft stud embedded centrally inside the cavity of the meter casing, and is held in place from above with the impeller shaft stud fixed in the cylindrical seat of the off-centered body.

An arched and a rectangular seat and a centered splined stud hole are formed on the front surface of the cylindrical skirt of the rotary valve. The curved seat is equipped with a curved gear rack, connecting to the drive gear of the electric motor moving the rotary valve. There are bores in the rectangular seat of the rotary valve, in which an optical sensor for detecting the rotation of the impeller and a thermometer are clamped. The optical sensor consists of an infrared light source and a photodiode, positioned collinearly, in parallel with or perpendicular to the shaft of the impeller, in the rectangular seat of the cylindrical skirt. A switching lever is clamped in the splined stud hole of the rotary valve, which rotates along with the rotary valve, and is used to control the quantity of the water flowing through the rotary valve. The center lines of the cavity of the meter casing, the impeller, the cylindrical seat of the rotary valve and the switching lever are collinear, allowing for the space-saving, compact design of the water meter.

A closing cover is affixed to the meter casing, resting on its rim, with a cylindrical recess cut into cover plate in order to accommodate the switching lever. Rotation end position limit switches are clamped in the seats formed in the closing cover, with which the switching lever, rotating together with the rotary valve, come into contact in order to control the rotation limit positions. Mounted on the closing cover are an electric motor connected to the curved gear rack of the curved seat via a gear on the cylindrical skirt of the rotary valve, as well as at least one battery, in addition to the fitting casing including the elements of the electric control unit. A groove is formed along the rim of the closing cover, encasing the teflon ring holding the rotary valve.

The compact water meter is equipped with a hermetically sealing housing, fitted with an aperture and covering the fitting casing and the closing cover. The quantity of water flowing through can be read on the LCD display of the device through the aperture, as indicated by the rotation of the impeller.

The storage spaces of the fitting casing and the closing cover house an electric control unit including voltage converter, control panel, relay module, LCD display, microswitches, LED signal-light, and at least one battery and an electric motor. An antenna connection is affixed onto the inner surface of the housing.

The operating principle of the compact water meter capable of remotely reading water consumption is a smart water meter, electrically powered by one or more batteries, operated by an electric motor and controlled by an electric control unit. The water flow is opened and shut off by the rotary valve powered by an electric motor and rotated with the help of a curved gear rack formed in the arched seat of the cylindrical skirt, with the device only requiring electric power during this process. The opening and shutting end positions of the rotary valve are controlled by the microswitches in the closing cover, which are operated by the switching lever when it comes into contact with them. The switching position of the switching lever pushed into the splined stud hole of the cylindrical skirt—and thus the opening and shutting position of the rotary valve—can be adjusted by modifying the angle of the switching lever.

An essential element of the invention is that it saves energy, as the compact water meter requires no power supply in either its opened or its shut position, and is capable of holding its set position indefinitely.

The rotation of the impeller allows for the measurement of water consumption both remotely, and on-site. The water flowing in the meter casing through the inlet stub drives the impeller by flowing through the through-flow channel. The infrared light source placed in the optical sensor emits light, which is reflected by the meter casing, after which it enters the photodiode. When water is let into the compact water meter and the impeller starts rotating, the blades of the impeller rotating in front of the optical sensor, covering both the infrared light source and the photodiode, the fact of which can be identified by the signal recorded by the photodiode. Both the rotation of the blades and the speed of the impeller can be determined based on this, thus making it possible to deduce the quantity of water flowing through.

The electric elements of the compact water meter are operated with 6V DC, using at least one battery. The control unit is in communication with an application installed on a mobile telecommunications device, usually the consumer's mobile phone, via the antenna. The opening and shutting off of the compact water meter, and the remote reading of the water consumption is controlled by the user with the application via the custom program algorithm. The electric equipment and the control system do not constitute the subject matter of the invention, therefore their detailed description is not included in the specification.

### BRIEF DESCRIPTION OF THE FIGURES

The invention will now be further described in detail with the help of a drawing via a non-limiting embodiment, wherein

FIG. 1 shows the compact water meter.

FIG. 2 shows the structural units of the compact water meter.

FIG. 3 shows the A-A section of FIG. 1.

FIG. 4 shows the meter casing.

FIG. 5 is a drawing of the profiled sealing,

FIGS. 6.1, 6.2 and 6.3 show the structure of the rotary valve.

FIG. 7 is a drawing of the drive gear of the electric motor.

FIG. 8 shows the impeller.

FIG. 9 is a drawing of the switching lever.

FIGS. 10.1 and 10.2 show the closing cover, and

FIG. 11 shows the fitting casing.

### DETAILED DESCRIPTION OF THE INVENTION

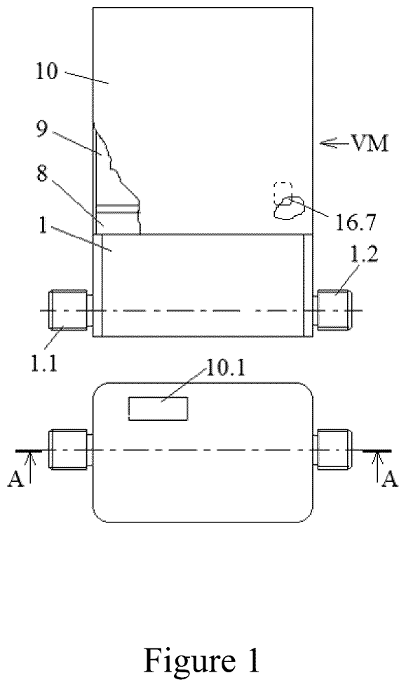

The structural subunits of the compact water meter (WM) shown on FIG. 1 are the meter casing 1 measuring the water consumption with an inlet stub 1.1 and an outlet stub 1.2, as well as the closing cover 8 with fitting casing 9, covering the meter casing 1, with these latter covered by the housing 10. The housing 10 is equipped with a transparent aperture 10.1, through which the water consumption can be read on the installation site. In the inner space of the housing 10, an antenna connection 16.7 providing telecommunications is affixed. The housing 10 is made of plastic in a way that it ensures hermetical sealing for the parts in the inner space, therefore it can be sealed and installed under water if required.

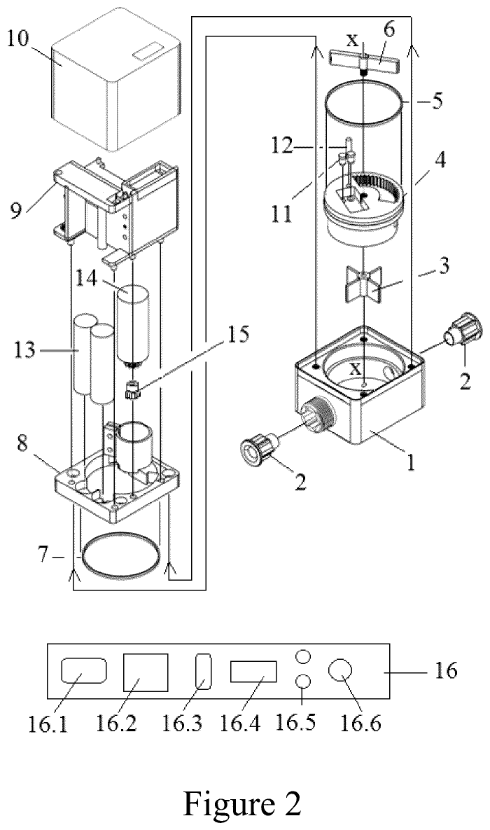

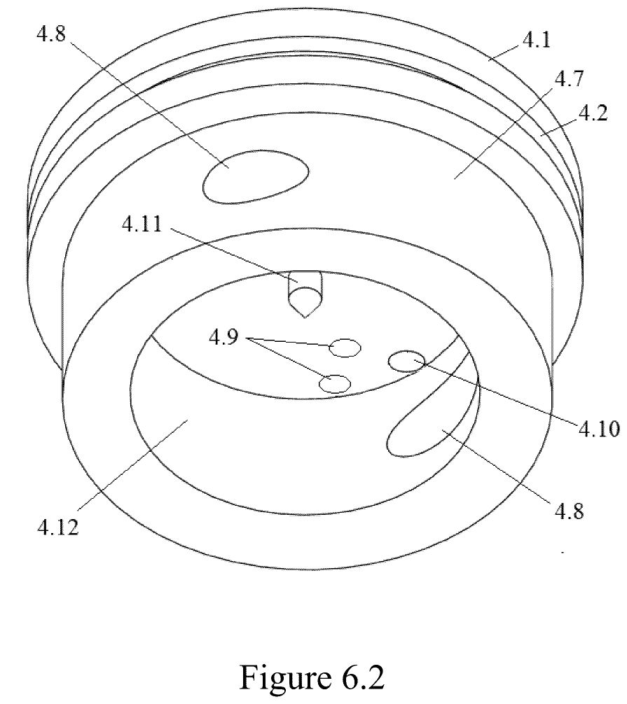

FIG. 2 shows the decomposed compact water meter (WM) with the following constituent parts: meter casing 1; profiled sealings 2, which are built in inlet stub 1.1 and outlet stub 1.2 of the meter casing 1 (see FIG. 1); impeller 3; rotary valve 4, whose cylindrical seat 4.12 (see FIG. 6.2) houses the impeller 3; teflon ring 5; switching lever 6, which is encased in the rotary valve 4 and regulates the water quantity flowing through the device; sealing 7, which seals the cylindrical surface of the rotary valve 4; closing cover 8, in which the teflon ring 5 is encased; fitting casing 9, which houses the control elements; housing 10. The figure shows that the center lines of the meter casing 1, the impeller 3, the rotary valve 4 and the switching lever 6 are collinear x-x.

The rotary valve 4 contains an optical sensor 11 and a thermometer 12. In our example, the closing cover 8 holds two batteries 13 and the electric motor 14 rotating the rotary valve 4 in open/shut position with the help of the gear 15.

The task of the electric control unit 16 is to allow for the remote reading of the water consumption using the antenna, to shut off or open the water flow at the rotary valve 4, and to provide information to the user. The electric control unit 16 installed in the fitting casing 9 includes a voltage converter 16.1, a control panel 16.2, a relay module 16.3, an LCD display 16.4, microswitches 16.5 and an LED signal-light 16.6. In the example shown, the voltage converter 16.1 produces stabile 5 V DC power supply using the DC voltage of the two serially connected batteries 13, which is required by the control panel 16.2 in the device. The voltage is released by the control panel 16.2 to the control elements, it provides the information package sent to the LCD display 16.4, it has a memory, runs the algorithm and ensures external communication via Wifi, GSM, or Bluetooth telecommunications devices. The relay module 16.3 closes the circuit of the electric motor 14. It consists of two, preferably solid-state relays, which connect the electric control unit 16 to the electric motor 14 with opposite directional current. The control panel 16.2 switches between the relays, switching to one when shutting off, and the other when opening the water flow. The LCD display 16.4 shows information to the user, which, depending on the controlling algorithm, can be water meter reading, valve position, water temperature, or other adjustable parameters. Two of the microswitches 16.5 provide input from the user to the controlling program, enabling navigation in the menu, and performing the functions determined by the algorithm. The other two microswitches define the thresholds of the two limit positions of the rotary valve, with the help of the switching lever 6. The LED signal-light 16.6 displays information as one of three colors for the user, which can be failure, impulse, program mode, low voltage, etc.

The electric motor 14 rotating the rotary valve 4 is a 6 V carbon-brush DC motor with a metallic drive gear. The batteries 13 are 3.7 V Li-ion types. The example shown has two of them in serial connection. The thermometer 12 provides information to the control electronics about the temperature of the water. The optical sensor 11 is an infrared switch with a pair of transceiver electronics, detecting the rotation of the impeller 3, based on which the algorithm is capable of determining the quantity of water flowing through.

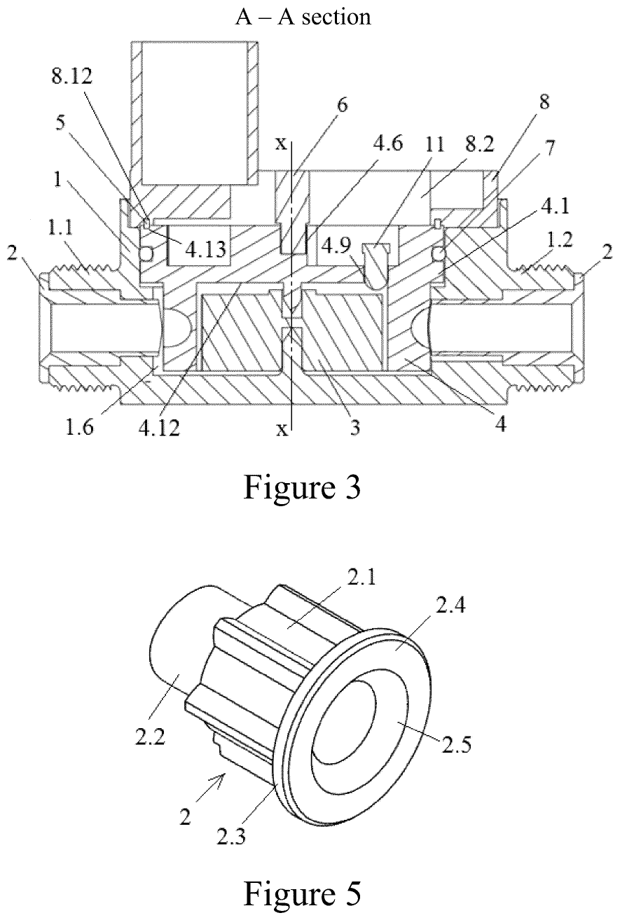

FIG. 3 shows the A-A section of FIG. 1, without the fitting casing 9 and housing 10. The figure shows the meter casing 1 with an inlet stub 1.1, outlet stub 1.2 and equipped with profiled sealings 2, in the cavity of which 1.6 is located the rotary valve 4 with sealing 7 on its cylindrical surface. A freely rotating impeller 3 is built into the cylindrical seat 4.12 of the rotary valve 4. The figure also shows the optical sensor 11 installed in the rotary valve 4. A closing cover 8 is affixed to the meter casing 1, containing a cylindrical recess 8.2 housing the switching lever 6 inserted in the splined stud hole 4.6 of the rotary valve 4.

A groove 8.12 is formed along the rim of the closing cover 8, encasing a teflon ring 5. The teflon ring 5 extends into the channel 4.13 formed along the cylindrical skirt rim 4.1 of the rotary valve 4. The height of the teflon ring 5 is larger than the total depth of the groove 8.12 and the channel 4.13 combined. The rotary valve 4 is stopped and held in place by the teflon ring 5 touching the bottom of the channel 4.13, when the shut off outlet stub 1.2, is lifted due to the water pressure present in the meter casing 1, and would be pressed against the closing cover 8 with great force. The teflon ring 5 is used to reduce the friction by considerably reducing the sizes of the surfaces coming into contact, i.e. the cover plate and the cylindrical skirt.

With an open compact water meter (WM), the water flows through the inlet stub 1.1 into the meter casing 1, rotating the impeller 3. The rotation of the impeller 3 allows for measuring the consumption. The optical sensor 11 placed in the sensor mounting bore 4.9 of the rotary valve 4 above the impeller 3 emits infrared light. This infrared light is reflected from the wall of the meter casing 1 and enters the photodiode placed in the optical sensor 11, wherein it is transformed into an electric signal which is then processed by the control panel 16.2 (see FIG. 2). When the impeller 3 rotates, its blades turn in front of the optical sensor 11, covering the infrared light source and the photodiode. This covering causes a periodic alteration in the signal recorded as the impeller 3 is rotating, which can be recorded and thus allows for deducing the rotational speed of the blades. There are two ways to place the optical sensor 11 in the rotary valve 4: the infrared light source and the photodiode can be mounted besides each other either parallel and perpendicular to the longitudinal axis of the impeller 3. If the infrared light source and the photodiode are placed parallel to the longitudinal axis, the rotating impeller 3 can cover them both at the same time. If they are placed perpendicular to the longitudinal axis, the impeller 3 will first cover the infrared light source, and then the photodiode, alternating between them. In both cases, the rotation of the impeller 3 can be identified from the measured signal.

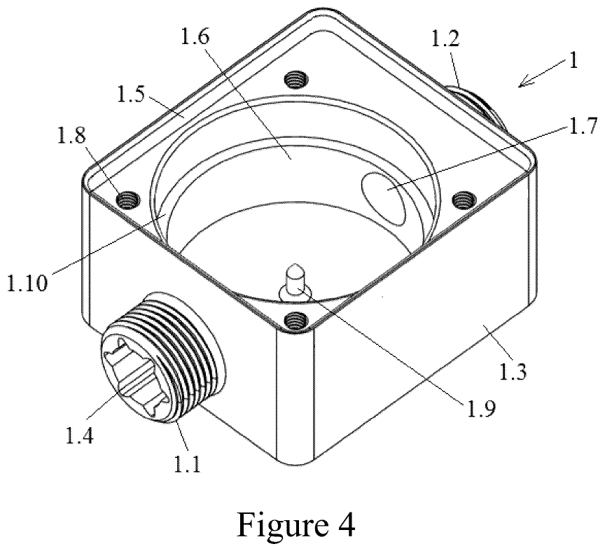

FIG. 4 shows the design of the meter casing 1. The threaded inlet stub 1.1 and the threaded outlet stub 1.2 are built into the casing body 1.3 of the meter casing 1 in front of each other, arranged along the same center line. The inlet stub 1.1 and the outlet stub 1.2 are provided with a splined seat 1.4, which fit into the splines of the profiled sealings 2 placed into the stubs, preventing the profiled sealings 2 from turning in the stubs. The rim 1.5 is formed along the upper edge of the casing body 1.3 for accommodating the closing cover 8 affixed onto the meter casing 1. The casing body 1.3 features a cylindrical cavity 1.6 made with the stepped cavity wall 1.10 for accommodating the rotary valve 4. The impeller shaft stud 1.9 is embedded in the middle of the bottom part of the casing body 1.3, with the bores 1.7 on the two side walls of the casing body 1.3 shaped to accommodate the inlet stub 1.1 and the outlet stub 1.2. Furthermore threaded drill holes 1.8 are also applied on the casing body 1.3 for accommodating the screws (not shown) clamping the closing cover 8.

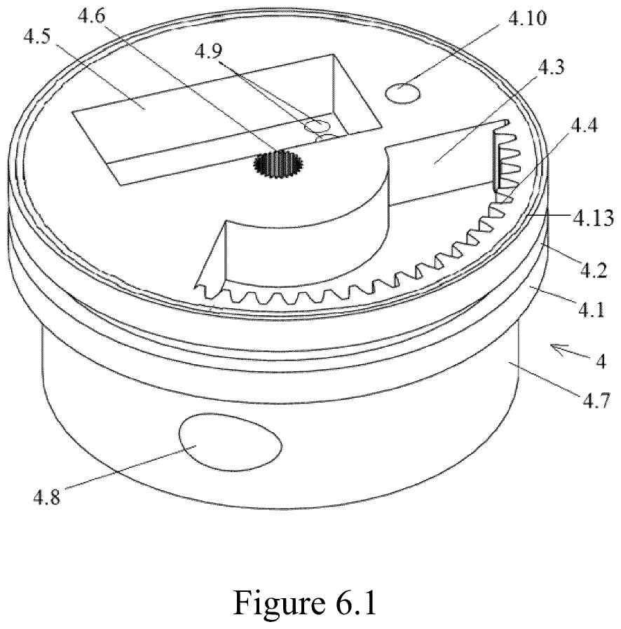

The profiled sealing 5 shown on FIG. 5 has a cylindrical body 2.1 and a splined body 2.2, whose shape fits to the inlet stub 1.1 and the outlet stub 1.2 bores of the meter casing 1. A rim 2.3 and a conical inlet 2.5 are formed on the free end of the splined body 2.2. The shape of the sealing end 2.4 of the cylindrical body 2.1 is slightly arched to fit to the rotary valve 4, and is pressed onto the rotary valve 4 when the water flow is opened.

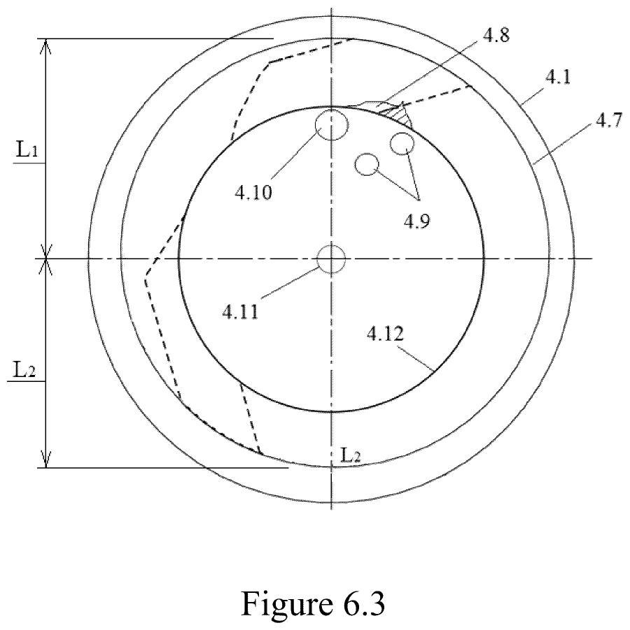

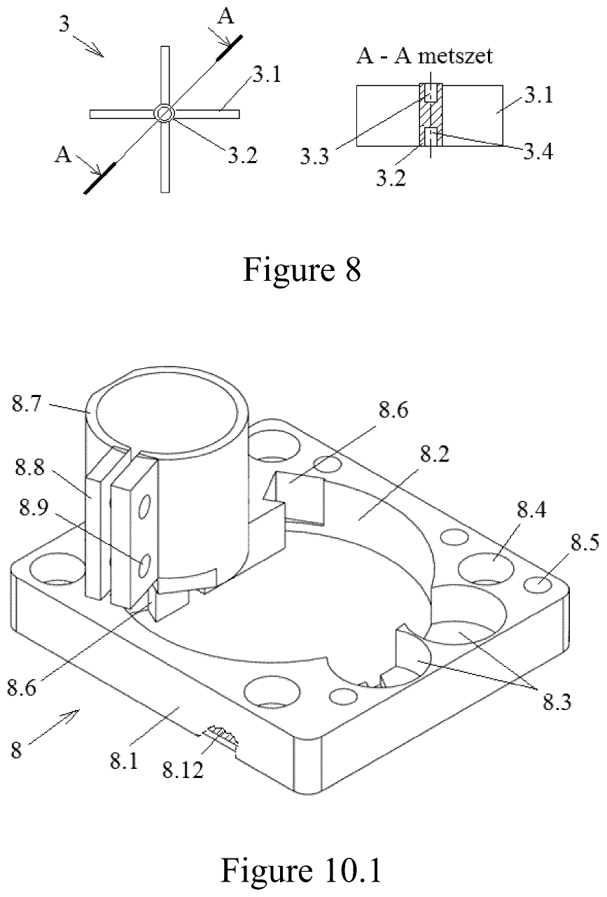

FIGS. 6.1, 6.2 and 6.3 show the structure of the rotary valve (4), which has a cylindrical skirt 4.1 and a off-centered body 4.7, the latter performing the shutting and opening of the water flow route. The sealing 7 is placed into the groove 4.2 formed on the cylindrical surface of the cylindrical skirt 4.1, which insulates the space above the cylindrical skirt 4.1 by being pressed onto the wall of the cavity 1.6 of the meter casing 1. The channel 4.13 running along the rim of the front plate of the cylindrical skirt 4.1 is formed to accommodate the teflon ring 5 (see FIGS. 2 and 3). The 4.3 curved seat including the curved gear rack 4.4, and the rectangular seat 4.5 including the through sensor mounting bore 4.9 and measuring device bore 4.10 are cut out on the front plate of the cylindrical skirt 4.1. The drive gear 15 of the electric motor 14 rotating the rotary valve 4 is connected to the curved gear rack 4.4 (see FIGS. 2 and 7). The infrared light source and photodiode of the optical sensor 11 needs to be clamped into the sensor mounting bores 4.9, while the measuring device bore 4.10 is for clamping the thermometer 12. A splined stud hole 4.6 is also formed centrally on the front plate of the cylindrical skirt 4.1, to which the splined stud 6.3 (see FIG. 9) of the switching lever 6 is to be connected.

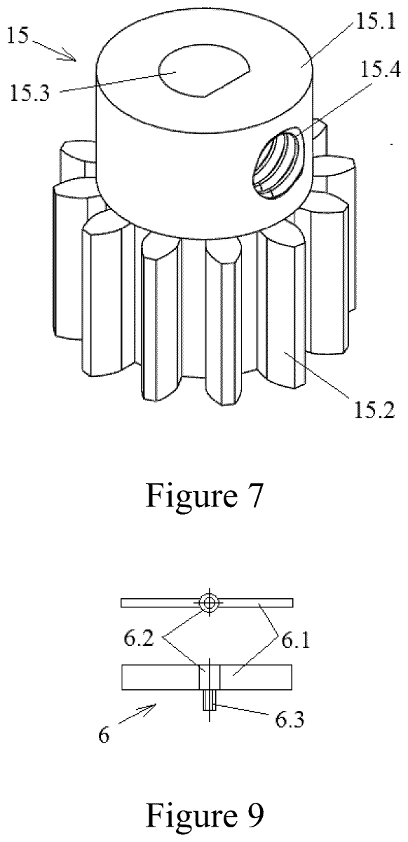

A through-flow channel 4.8 is led through the off-centered body 4.7, whose position is aligned with the inlet stub 1.1 and outlet stub 1.2 of the meter casing 1. The cylindrical seat 4.12 accommodating the impeller 3 is formed in the off-centered body 4.7, in which the impeller shaft stud 4.11 is centrally clamped, fitting in the bore 3.1 (see FIG. 8) of the impeller 3 to keep the impeller 3 in place. FIG. 6.3 shows the positions of the off-centered body 4.7 and the cylindrical skirt 4.1 relative to each other. The off-centered body 4.7 is formed by combining the areas of two circles of the same radius but shifted centers. The arrangement is shown on the figure with chords L₁ and L₂, wherein the center of the circle with L₂ radius is the center of rotation (center of the impeller shaft stud 4.11) and L₁ is approximately 0.5-1.5 mm larger than L₂. The rotating off-centered body 4.7 allows for opening and shutting off the water flow in the meter casing 1 with very little friction, due to its off-centered design.

FIG. 7 is the drawing of the drive gear 15 of the electric motor 14. The gear 15 has a cylindrical body 15.1 and a gear body 15.2 with a shaft hole 15.3 going through it. A threaded bore 15.4 is formed on the cylindrical body 15.1, through which the gear 15 can be affixed with a screw on the shaft of the drive gear of the electric motor 14.

FIG. 8 shows the design of the impeller 3. The impeller 3 consists of four blades 3.1 at right angles to each other, extending from the shaft 3.2, with bores 3.3, 3.4 drilled through them. The impeller 3 is built into the cylindrical seat 4.12 of the off-centered body 4.7 of the rotary valve 4, wherein the impeller shaft stud 4.11 clamped into the cylindrical seat 4.12 (see FIG. 6.2) is inserted into the upper bore 3.3 of the shaft 3.2. The impeller shaft stud 1.9 (see FIG. 4) clamped in the center of the bottom part of the casing body 1.3 is inserted into the lower bore 3.4 of the shaft 3.2.

FIG. 9 shows the switching lever 6 including two switching plates 6.1 in one plane, connected to the shaft 6.2. A splined stud 6.3 is located at the end of the shaft 6.2, which is to be inserted into the splined stud hole 4.6 (see FIG. 6.1) formed centrally on the front plate of the cylindrical skirt 4.1 of the rotary valve 4. The switching lever 6 can be clamped into the stud hole 4.6 in any position for regulating the quantity of water flowing through the compact water meter (WM), and for opening or shutting off the water flow.

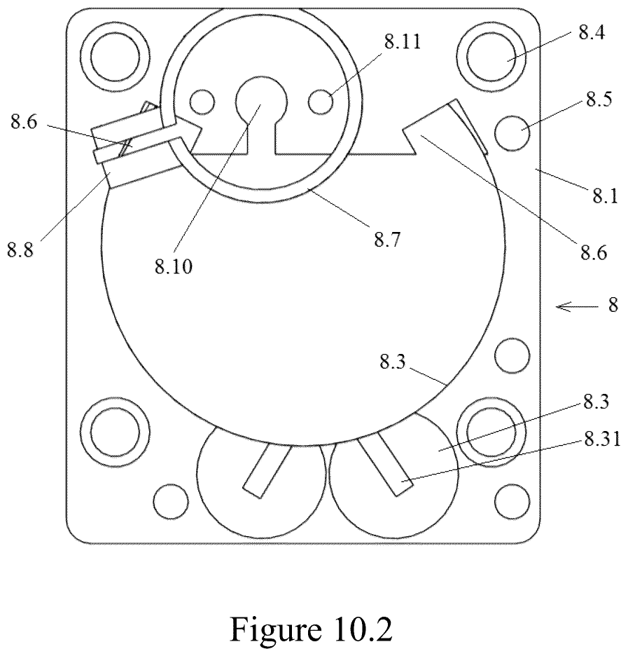

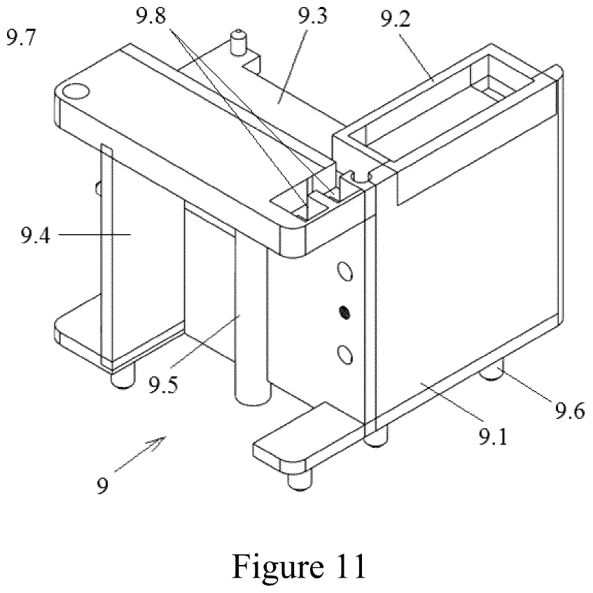

FIGS. 10.1 and 10.2 show the closing cover 8. The cover plate 8.1 of the closing cover 8 houses a cylindrical recess 8.2, a battery seat 8.3, four mounting bores 8.4, four positioning stud bores 8.5 and a fastening clamp 8.7. The cylindrical recess 8.2 includes the switching lever 6 which is equipped with two limit switch seats 8.6 at its two ends, holding the microswitches 16.5. The switching lever 6 rotating along with the rotary valve 4 controls the rotation of the rotary valve 4 by contacting the microswitches 16.5, and thus quantitatively regulates the flow of water, opening and shutting it as needed. The battery seat 8.3 is designed to accommodate the batteries 13, with the recess 8.31 at the bottom of the seat allowing space for the electrical wiring. The closing cover 8 can be affixed on the meter casing 1 with screws (not shown) placed into the mounting bores 8.4. The positioning stud bores 8.5 are used to accommodate the positioning studs 9.6 (see FIG. 11) of the fitting casing 9. The slotted fastening clamp 8.7 holds the electric motor 14, wherein the strength of the clamping can be set by the screws (not represented) let through the bores 8.9 of the clamping plates 8.8 at the edges of the fastening clamp 8.7 slot. The drive shaft of the electric motor 14 can be led out from the closing cover 8 through the shaft passage aperture 8.10 of the cover plate 8.1, while the electrical wiring can be led out to the cover plate 8.1 through the bores 8.11. The teflon ring 5 is placed in the groove 8.12 running along the rim of the bottom part of the cover plate 8.1 (see FIG. 3).

FIG. 11 shows the fitting casing 9, housing the integrated relay module holder 9.1, the LCD display holder 9.2, the control panel holder 9.3, the fuse holder 9.4, the electrical cable guides 9.5, the LED signal-light seat 9.7 and the microswitch holder 9.8. The appropriate placement of the fitting casing 9 on the closing cover 8 is ensured by inserting the positioning studs 9.6 at the bottom of the fitting casing 9 in the positioning stud bores 8.5 of the closing cover 8.

The electric control unit 16 can be instructed via the application installed on a telecommunications device, usually a mobile phone, to open and shut off the compact water meter (WM), and can be used to remotely read of the water consumption. The unit can be controlled by the user with the application, via the custom program algorithm. The controlling electronics can be connected to a GSM module, allowing the device to be controlled via a mobile telecommunications network. The other option is to connect the electric control unit 16 to a Wifi antenna, through which the compact water meter (WM) can be connected to the wireless local area network (WLAN). If the local network is connected to the internet, the compact water meter (WM) can be controlled through the internet.

Based on the above, it is clear that the compact water meter embodied by the invention is suitable for resolving the tasks outlined in the objectives, because it allows for remote reading of the water consumption, its use saves energy, as it only requires electrical power when switching to the open or shut off position, and otherwise does not use any power. Furthermore, it can also be operated remotely, and its structure is simple, requiring no special maintenance. For the present invention, the valve and the meter casing are integrated into a single unit, resulting in a compact device that takes up much less space than other known solutions.

### LIST OF REFERENCE ITEMS

WM—water meter
1—meter casing
1.1—inlet stub
1.2—outlet stub
1.3—casing body
1.4—seat
1.5—rim
1.6—(cylindrical) cavity
1.7—bore
1.8—threaded bore
1.9—impeller shaft stud
1.10—stepped cavity wall
2—profiled sealing
2.1—cylindrical body
2.2—splined body
2.3—rim
2.4—sealing end
2.5—conical inlet
3—impeller
3.1—blade
3.2—shaft
3.3—bore
3.4—bore
4—rotary valve
4.1—cylindrical skirt
4.2—groove
4.3—curved seat
4.4—curved gear rack
4.5—rectangular seat
4.6—splined stud hole
4.7—oval body
4.8—through-flow channel
4.9—sensor mounting bore
4.10—measuring device bore
4.11—impeller shaft stud
4.12—cylindrical seat
4.13—channel
5—teflon ring
6—switching lever
6.1—switching plate
6.2—shaft
6.3—splined stud
7—sealing
8—closing cover
8.1—cover plate
8.2—cylindrical recess
8.3—battery seat
8.31—recess
8.4—mounting bore
8.5—positioning stud bore
8.6—limit switch seat
8.7—fastening clamp
8.8—clamping plate
8.9—bore
8.10—shaft passage aperture
8.11—bore
8.12—groove
9—fitting casing
9.1—relay module holder
9.2—LED display holder
9.3—control panel holder
9.4—fuse holder
9.5—electrical cable guide
9.6—positioning stud
9.7—LED signal-light seat
9.8—microswitch holder
10—housing
10.1—aperture
11—optical sensor
12—thermometer
13—battery
14—electric motor
15—gear
15.1—cylindrical body
15.2—gear body
15.3—shaft hole
15.4—threaded bore
16—electric control unit
16.1—voltage converter
16.2—control panel
16.3—relay module
16.4—LCD display
16.5—microswitches
16.6—LED signal—light
16.7—antenna connection
L1, L2—chord
x—x axis

1. A compact water meter, comprising
a meter casing equipped with an inlet stub and an outlet stub;
a rotary valve provided with a through-flow channel placed in the cavity of the meter casing, wherein the through-flow channel of the rotary valve connects to the inlet stub and outlet stub of the meter casing;
a rotatably embedded impeller in the cylindrical seat of the rotary valve;
a curved gear rack formed in the arched seat of the rotary valve;
an optical sensor placed in the sensor mounting bores formed in the rectangular seat of the rotary valve, and a thermometer placed in the measuring device bores;
a switching lever clamped in the centered splined stud hole of the rotary valve;
a closing cover including a switching lever affixed to the meter casing, on which an electric motor connected to the curved gear rack of the rotary valve and at least one battery are mounted; and
a fitting casing including an electric control unit affixed to the closing cover, wherein the center lines of the cavity of the meter casing, the impeller, the cylindrical seat of the rotary valve and the switching lever are collinear.

2. Compact water meter according to claim 1, wherein an impeller shaft stud is mounted centrally inside the cavity of the meter casing.

3. Compact water meter according to claim 1, wherein splined profiled sealings are built in the inlet stub and the outlet stub of the meter casing.

4. Compact water meter according to claim 1, wherein a rim is formed on the meter casing for supporting the closing cover.

5. Compact water meter according to claim 1, wherein the rotary valve has an off-centered body and a cylindrical skirt with a rimmed channel.

6. Compact water meter according to claim 5, wherein a sealing is placed in the groove formed on the surface of the cylindrical skirt.

7. Compact water meter according to claim 1, wherein the through-flow channel is formed in the off-centered body of the rotary valve.

8. Compact water meter according to claim 7, wherein the off-centered body has a cylindrical seat in which an impeller shaft stud is mounted centrally.

9. Compact water meter according to claim 1, wherein the optical sensor consists of an infrared light source and a photodiode.

10. Compact water meter according to claim 9, wherein the infrared light source and the photodiode are positioned collinearly, either parallel with or perpendicular to the shaft of the impeller, in the rectangular seat of the cylindrical skirt.

11. Compact water meter according to claim 1, wherein the cover plate of the closing cover has a cylindrical recess accommodating the switching lever.

12. Compact water meter according to claim 11, wherein at least one battery seat and limit switch seats are formed in the cover plate.

13. Compact water meter according to claim 11, wherein the closing cover has a fastening clamp accommodating the electric motor.

14. Compact water meter according to claim 12, wherein the cover plate is provided with a groove along its rim, accommodating a teflon ring.

15. Compact water meter according to claim 1, wherein the electric motor is connected with a gear to the curved gear rack formed in the arched seat of the rotary valve.

16. Compact water meter according to claim 1, that has a housing equipped with an aperture that covers the fitting casing and the closing cover.

17. Compact water meter according to claim 16, wherein the housing of the fitting casing is equipped with a telecommunications antenna connection.
